(19) United States
(12) Patent Application Publication
(10) Pub. No.: US 2014/0358779 A1
(43) Pub. Date: Dec. 4, 2014

(54) Method Of Conducting Financial Transactions Using A Phone Node In Communication With A Transactional Server

(71) Applicant: Windrose Mena Limited, Glasgow (GB)

(72) Inventor: Zohair Barakat El-Sakka, Amman (JO)

(21) Appl. No.: 13/909,844

(22) Filed: Jun. 4, 2013

(51) Int. Cl. G06Q 20/16

(52) U.S. Cl. CPC G06Q 20/16
USPC 705/44; 705/39

(57) ABSTRACT

The present invention relates to a method of conducting financial transactions using a phone node in communication with a transactional server, wherein such method uses telephone numbers as identifiers to the financial values transacted. Each financial account is mapped to a plurality of value-related telephone numbers, wherein such numbers correspond to a payee. The payment transaction starts when a payer dials the value-related telephone number programmed with the financial value that corresponds to his financial account, then a telephony PBX node hangs up on the payer and the value is credited from the payer's financial account and is debited to the payee's financial account. In the method of the present invention, the payee maps the value-related phone number to the financial values, and stores said mapped data of the transactional server prior to conducting the financial transaction. The method of the present invention can be applied in person-to-person transactions, web payment transactions, merchant payments, or in vending machines. The present invention does not need any special infrastructure giving such invention an advantage.

### FIELD OF THE INVENTION

The present invention relates to a method of conducting financial transactions using a phone node in communication with a transactional server, and more particularly to a method that uses value-related telephone numbers for doing such transactions.

### BACKGROUND OF THE INVENTION

There are various conventional solutions of conducting financial transactions using a phone node in communication with a transactional server disclosed in the prior art, among these conventional solutions, a system and method for purchasing a product from an automatic vending machine by means of a consumer's cellular telephone is disclosed. In such conventional solution, the consumer requests the purchase of a product available from the vending machine by dialing a specified telephone number which connects the consumer's cellular telephone to a server operated by a billing agency. The billing agency may include the provider of the product, the telephone company that provides the cellular telephone service, a credit card company, or a bank that has issued a debit card. The server recognizes the request for the purchase of the product as either the request for credit at the vending machine or the request for a particular product, creates a transaction record, and communicates a vend code to the consumer. The transaction record includes a billing record that the billing agency uses to bill the consumer for the requested product and an inventory record that the product provider uses in connection with restocking the vending machine. Upon receiving the vend code from the server, the consumer transmits the vend code to the vending machine. The vend code may be an RF code, an audible tone code, or a manual code. Upon receipt of the vend code from the consumer, the vending machine either establishes credit for the purchase of a product in the inventory of the vending machine or directly dispenses the requested product upon receipt of the vend code.

Another conventional solution discloses a system to perform electronic payments comprising a mobile with an identification number assigned to it; a remote server comprising interactive voice response (IVR) means, at least one database linked to said remote server for storing a variety of network identification numbers assigned to buyable products and services, wherein the remote server receives a call from the mobile, identifies the specific identification number associated to the mobile and the network identification number dialed by said mobile, said call prompting the remote server to search the data stored on the at least one database in order to determine whether the mobile identification number and the network number dialed are registered and whether a transaction is possible; said determination prompting the remote server to disconnect the call made by the mobile without ever answering it.

An additional conventional solution discloses a method of payment by mutual account transfer through mobile phones and a system thereof. A payee and a payer in advance package each bank account number with each mobile phone number in an account transfer center, after setting each payment password, the payee sends collection request information to the account transfer center by a mobile phone thereof during the payment by account transfer, the payer sends payment request information to the account transfer center, and after the account transfer center reviews the collection request information of the payee and the payer checks that the payment request information is correct, the amount required in the payment request information is transferred from the bank account packaged with the mobile phone of the payer to the bank account packaged with the mobile phone of the payee. The method is characterized in that the payee and the payer can transfer account at any time and any place, and only by carrying out relative operation by mobile phone, money in the bank account of the payer can be transferred into the bank account of the payee.

Another conventional solution discloses a system allowing for the use of any type of mobile telephone as an activating equipment for payment devices using any mobile telephone network employing any technology in any country connected to the system. Includes a group of payment and operations processing centers in different countries, which are interconnected through international addressing processors to carry out transactions and payments among users-payers and beneficiaries associated to the system in either the same or different countries. The centers have a specific structure in order to allow for different types of purchases, consultations, modifications, and the authentication of payment devices. The system allows for all of the different messages exchanged to use voice messaging. In addition the system allows for the use of a mobile telephone of a beneficiary/merchant as a POS to carry out transactions.

In the prior art systems and methods, a voice message or a vend code is sent to the payer for confirming the transaction, which will complicate the transaction process. Also, the financial values of the numbers are fixed and cannot be programmed at the instance of the payment which hinders the flexibility of implementing these methods.

### SUMMARY OF THE INVENTION

It is therefore an object of the present invention to provide a method of conducting financial transactions using a phone node in communication with a transactional server which overcomes the above mentioned drawbacks.

The present invention relates to a method of conducting financial transactions using a phone node in communication with a transactional server, and more particularly to a method that uses value-related telephone numbers for doing such transactions.

As a first aspect of the invention, there is provided a method of conducting financial transactions using a phone node in communication with a transactional server, wherein such method uses telephone numbers as identifiers to the financial values transacted. Each financial account is mapped to a plurality of value-related telephone numbers. A value-related telephone number is a phone number that is assigned to represent a specific financial value in the course of financial transactions. Each payee is assigned a unique identifier used to authenticate the payee as well as a master phone number to be dialed for remotely and dynamically assigning phone numbers to specific financial values. The payee maps a specific financial value to each one of the plurality of value-related financial values respectively. The payee is enabled to dynamically assign financial values to value-related phone numbers by dialing the master number. The operator enables the payee to specify a financial value for each phone number.

The financial transaction method starts when a payer dials the value-related telephone number that is programmed with the financial value that corresponds to his financial account he/she wants to conduct the transaction from, then a telephone PBX node hangs up on the payer without answering the call. A check if the payer is registered for the service is done upon hanging up the call, then, if he/she is registered for the service suitable credit check is done upon hanging up the call; wherein these checks are done in real time. If the results of these checks were affirmative, the amount of the financial value programmed on the dialed telephone number is credited from the payer's financial account corresponding to the dialed value-related telephone number and debited to the payee's financial account linked to the dialed telephone number, then a text message is sent to both the payee and payer informing them that the transaction is completed successfully.

Each payer has a unique identifier, wherein each identifier comprise mobile phone numbers, landline phone, IP addresses or MAC addresses.

Preferably, the financial transaction can be a person-to-person transaction, a web payment transaction, a merchant payment, or a vending machine payment.

### BRIEF DESCRIPTION OF THE DRAWINGS

The invention will now be described with reference to the accompanying drawings, which illustrate a preferred embodiment of the present invention without restricting the scope of the invention's concept, and in which:

FIGS. 1A and B illustrate a flow chart showing the steps of a method of conducting financial transactions from financial accounts using a phone node in communication with a transactional server configured according to a preferred embodiment of the present invention.

FIG. 2 illustrates a schematic diagram of a method of conducting financial transactions from financial accounts using a phone node in communication with a transactional server configured according to a preferred embodiment of the present invention, applied via programming values from phone to server.

FIG. 3 illustrates a schematic diagram of a method of conducting financial transactions from financial accounts using a phone node in communication with a transactional server configured according to a preferred embodiment of the present invention, applied using person-to-person financial transaction.

FIG. 4 illustrates a schematic diagram of a method of conducting financial transactions from financial accounts using a phone node in communication with a transactional server configured according to a preferred embodiment of the present invention, applied using cash registry.

FIG. 5 illustrates a schematic diagram of a method of conducting financial transactions from financial accounts using a phone node in communication with a transactional server configured according to a preferred embodiment of the present invention, applied using internet shopping.

FIG. 6 illustrates a schematic diagram of a method of conducting financial transactions from financial accounts using a phone node in communication with a transactional server configured according to a preferred embodiment of the present invention, applied using vending machine.

### DETAILED DESCRIPTION OF THE PREFERRED EMBODIMENT

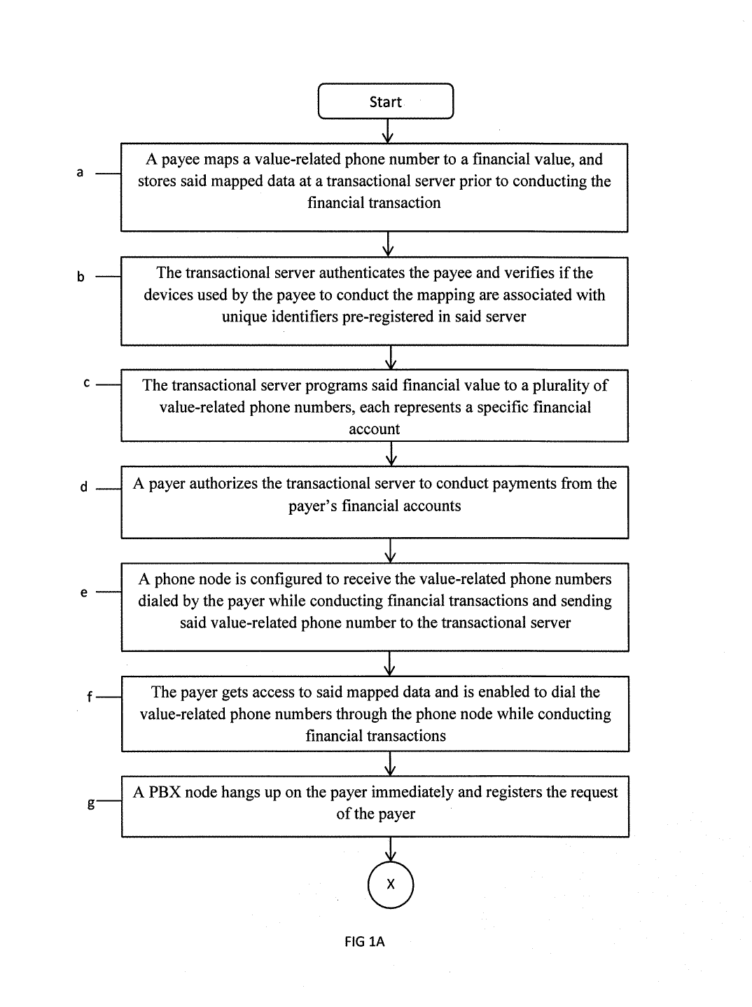

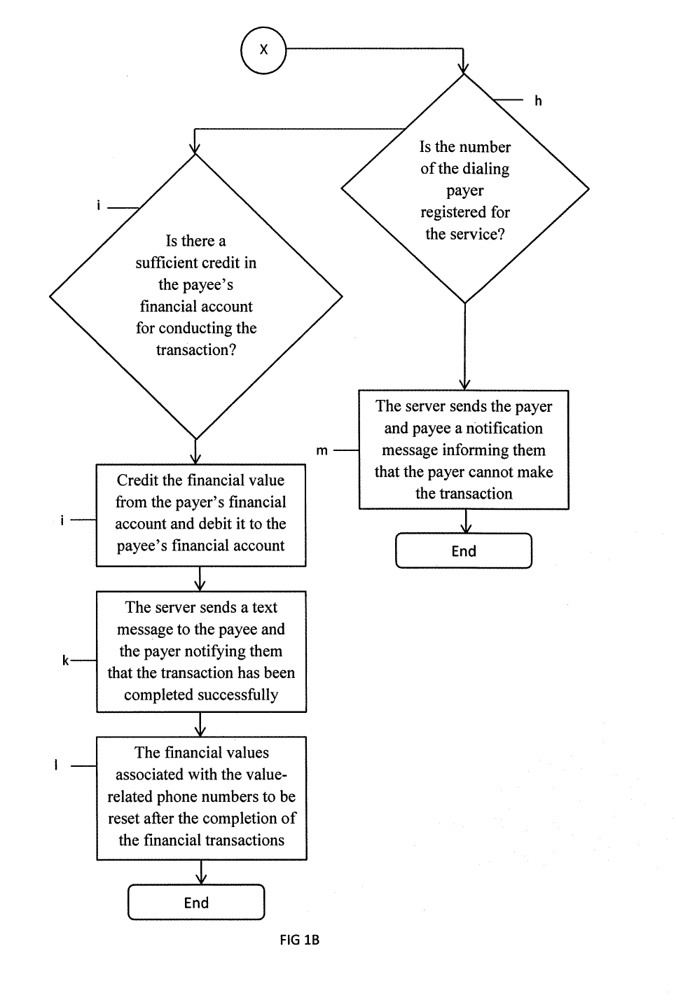

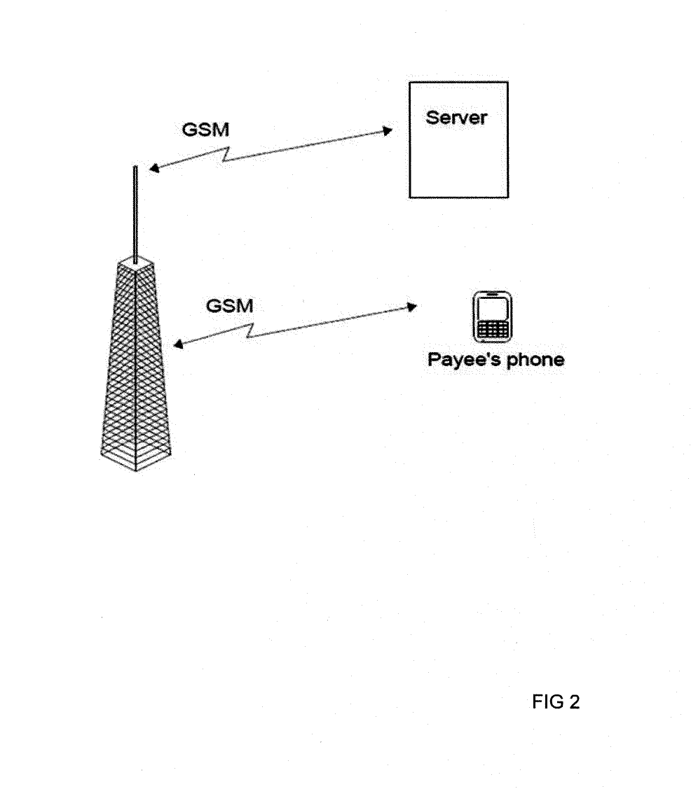

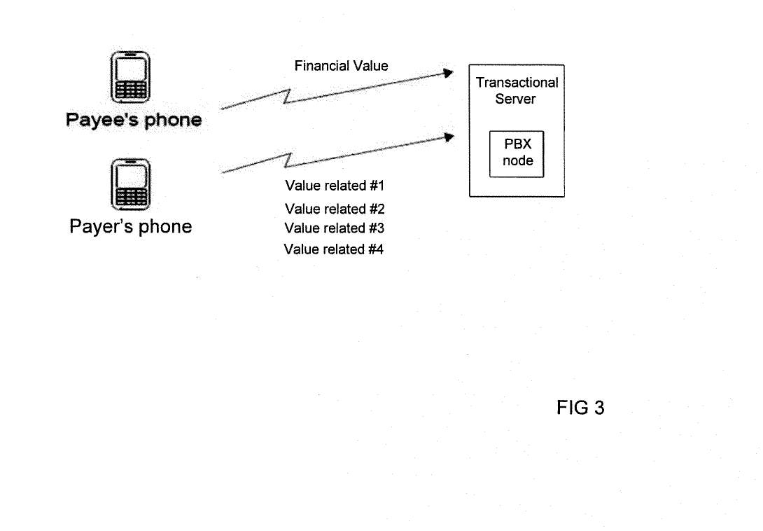

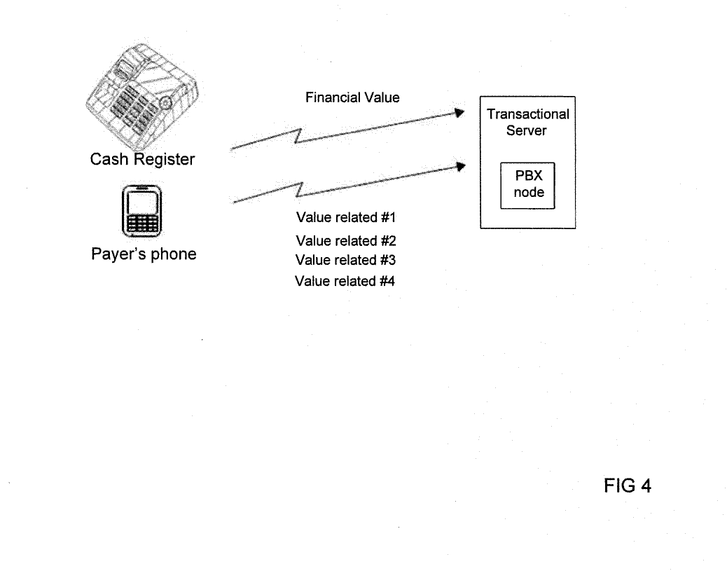

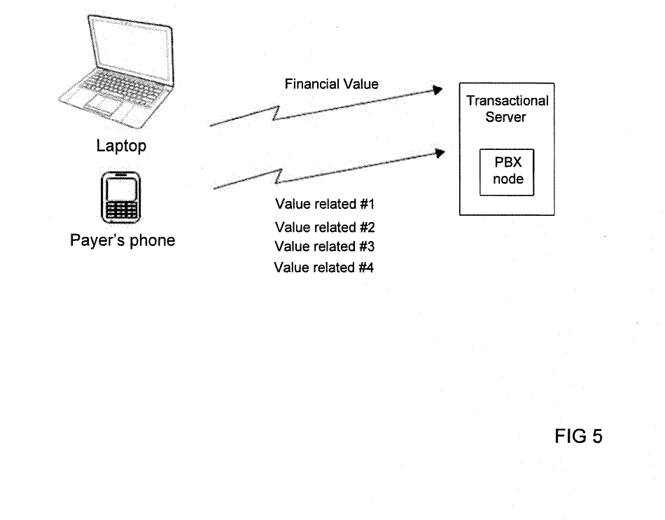

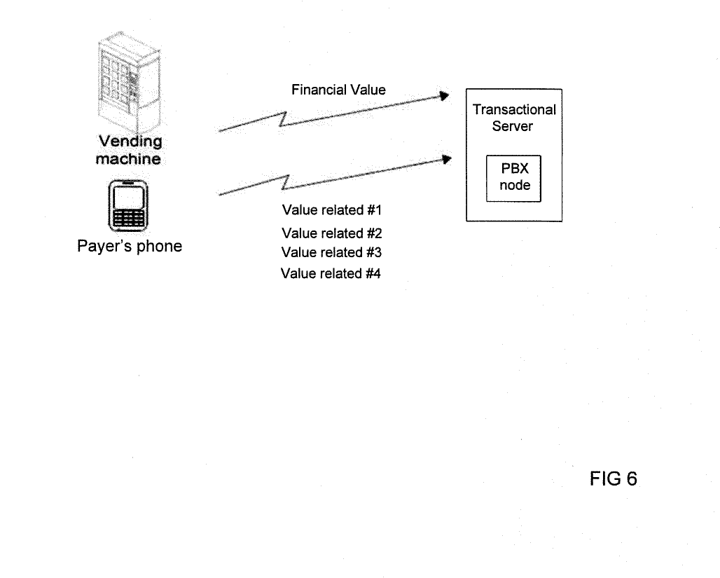

FIGS. 1 to 6 illustrate a method of conducting financial transactions using a phone node in communication with a transactional server configured according to a preferred embodiment of the present invention. Such method comprises the following steps:
a. A payee maps a value-related phone number to a financial value, and stores said mapped data at the transactional server prior to conducting the financial transaction;
b. The transactional server authenticates the payee and verifies if the devices used by the payee to conduct the mapping are associated with unique identifiers pre-registered in said server;
c. The transactional server programs said financial value to the plurality of value-related phone numbers, each represents a specific financial account;
d. The payer authorizes the transactional server to conduct payments from the payer's financial accounts;
e. A phone node is configured to receive the value-related phone numbers dialed by the payer while conducting financial transactions and sending said value-related phone number to the transactional server;
f. The payer gets access to said mapped data and is enabled to dial the value-related phone numbers through the phone node while conducting financial transactions;
g. A PBX node found in the server corresponding to the service provider hangs up on the payer immediately and registers the request of the payer;
h. The server checks if the calling telephone number is registered in the service;
i. A credit check for the payer account to be conducted (using one of the known credit check methods) to make sure that the payer has sufficient credit in his/her account;
j. If the payer has sufficient credit in his/her financial account, the financial value programmed on the dialed telephone number will be credited from his/her financial account and debited to the payee's financial account;
k. The server sends a text message to the payee and the payer notifying them that the transaction was completed successfully;
l. The financial values associated with the value-related phone numbers to be reset after the completion of the financial transactions.
m. If results of the checks at step (h & i) were negative, the server sends the payer and the payee a text message informing them that the payer cannot make the transaction;

In the preferred embodiment of the present invention, each payee has a unique identifier, wherein the unique identifier comprise mobile phone numbers, landline phone, IP addresses or MAC addresses.

In the method of the present invention, the master number is preferably a telephone number; either landline telephone number or a mobile telephone number.

In the method of the present invention, the payer should authorize the transactional server to conduct payments from their financial accounts before starting the transaction process.

Each of said value related phone numbers corresponds to a financial account, wherein such financial accounts could be a bank account, a credit card account, a telephone bill account, or a pre-paid account, wherein such value related phone numbers are either a mobile phone number or a landline phone number.

In the preferred embodiment of the present invention, if said financial account is a telephone bill, said credit check step is not necessary, and said financial value will be loaded on the telephone bill of the payer.

In the method of the present invention, the financial accounts of the payer from which the financial value of the transaction could be credited should be pre-identified to the service provider.

In the preferred embodiment of the present invention, the payee's financial account to which the financial value of the transaction will be debited should be pre-identified to the service provider.

The method of the present invention can be applied in person-to-person transactions, web payment transactions, merchant payments, or in vending machines.

The transactional server at the financial institution should have a PBX node, a processor, a database, and a memory.

The invention will be further described and illustrated for the preferred embodiment of this invention, which is a method of conducting financial transactions from financial accounts using telephony networks, in the following examples.

### EXAMPLES

The following examples illustrate the present invention without, however, limiting the same thereto.

### Example 1

### Person-to-Person Financial Transaction Using the Preferred Embodiment of the Present Invention

The preferred embodiment of the present invention can be applied in person-to-person payments. The payee sends a command through his/her unique identification number to the transactional server to program said pre-identified value-related telephone numbers each number of said pre-identified value-related telephone numbers corresponds to a different financial value. After such value-related telephone numbers are programmed, the payee sends the payer such numbers. Then, the payer dials the value-related telephone number that corresponds to . . . the financial value representing the cost for such products or services to be paid for. A check for the registration of the dialing number in the service and a check if the credit in the financial account linked to the dialing number from which the payment will be done is sufficient are done. If the results of these checks are positive, then a text message is sent to the dialing number and to the payee's notifying the payee and the payer that the transaction is done successfully, and the programmed financial value on said pre-identified value-related telephone numbers is reset.

### Example 2

### Web Payment Financial Transaction Using the Preferred Embodiment of the Present Invention

The preferred embodiment of the present invention can be applied in web payments for buying a product, a service, a plurality of products, or a plurality of services. When the buyer finishes the selection of such products or services, the website through its unique identifier sends a command to the transactional server to program said value-related telephone numbers with the financial value of the total price of such products or services. Each number of such value-related telephone numbers corresponds to a different financial value. After such value-related telephone numbers are programmed, the website displays such numbers for the buyer. Then, the buyer dials the telephone number that corresponds to the financial value representing the cost of the products or services to pay for. A check for the registration of the dialing number in the service and a check if the credit in the financial account linked to the dialing number from which the payment will be done is sufficient. If the results of these checks are positive, then a text message is sent to the dialing number notifying the dialer that the transaction is done successfully, and a message is displayed on the website notifying the buyer that the transaction has been done successfully, and the programmed financial value on said pre-identified value-related telephone numbers is reset.

### Example 3

### Merchant Payment Transactions Using the Preferred Embodiment of the Present Invention

The preferred embodiment of the present invention can be applied in merchant payments for buying a product, a service, a plurality of products, or a plurality of services. When the buyer finishes the selection of such products or services, merchant or the cashier in the shop through the unique identifier of the merchant sends a command to the transactional server to program a value-related telephone numbers with financial values respectively corresponding to the prices of different products or services. After such value-related telephone numbers are programmed, the merchant sends the value-related numbers to the buyer. Then, the buyer dials the telephone number that corresponds to the financial value of the product or service to pay for. A check for the registration of the dialing number in the service and a check if the credit in the financial account linked to the dialing number from which the payment will be done is sufficient. If the results of these checks are positive, then a text message is sent to the dialing number notifying the merchant or cashier and the dialer that the transaction is done successfully, and the programmed financial value on said pre-identified value-related telephone numbers is reset.

### Example 4

### Vending Machine Purchases Using the Preferred Embodiment of the Present Invention

The preferred embodiment of the present invention can be applied in vending machine payments. The owner of the vending machine sends a command through his/her unique identifier to the transactional server to program said value-related telephone numbers. Each number of the value-related telephone numbers corresponds to a financial value. After such value-related telephone numbers are programmed, the owner of such vending machine displays such value-related telephone numbers on the vending machine. In this case, each item offered in the vending machine has a plurality of said value-related telephone numbers displayed on the machine. Then, the payer dials the telephone number that corresponds to the financial value representing the price of the product or service to pay for. A check for the registration of the dialing number in the service and a check if the credit in the financial account linked to the dialing number from which the payment will be done is sufficient are done. If the results of these checks are positive, then a text message is sent to the dialing number notifying the payee and the buyer that the transaction is done successfully, and the offered item is released from such machine.

Although the above description of the present invention has disclosed the features of the invention as applied to the preferred embodiment; additions, omissions and modifications applied to the details of the embodiment illustrated may be made by those skilled in the art without departing from the essential characteristic of the present invention.

1. A method of conducting financial transactions using a phone node in communication with a transactional server, the method comprising mapping value-related phone numbers to financial values and storing said mapped data at said transactional server, providing said users access to said mapping data, enabling users to dial the value-related phone numbers through the phone node while conducting financial transactions, and attributing by said transactional server financial values to the financial transactions based on the value-related phone numbers dialed by the users and on the mapping data.

2. The method as claimed in claim 1, wherein the mapping of value-related phone numbers to specific financial values is carried out by merchants through the phone node prior to conducting the financial transactions.

3. The method as claimed in claim 2, wherein the mapping of value-related phone numbers requires prior authentication of the merchants.

4. The method as claimed in claim 3, wherein said authentication consists of verifying if the devices used by the merchants to conduct the mapping are associated with unique identifiers pre-registered in association with the merchants at said transaction server.

5. The method as claimed in claim 4, wherein said authentication is carried out by said transactional server.

6. The method as claimed in claim 5, wherein the unique identifiers comprise mobile phone numbers, landline phone numbers, IP addresses or MAC addresses.

7. The method as claimed in claim 1, wherein said mapping is conducted by the users at the time of conducting the financial transactions, the financial values associated with the value-related phone numbers being reset after the completion of the financial transactions.

8. A system comprising:
a transactional server comprising mapping data mapping value-related phone numbers to financial values;
a phone node configured to receive the value-related phone numbers dialed by users while conducting financial transactions;
the transaction server being in communication with the phone node for receiving the dialed value-related phone numbers and for attributing financial values to the financial transactions based on the value-related phone numbers dialed by the users and on the mapping data stored at the transactional server.

9. The system as claimed in claim 8, wherein said mapping value-related phone numbers to financial values is carried out by merchants prior to conducting the financial transactions.

10. The system as claimed in claim 9, wherein the transaction server authenticates the merchants before enabling said merchants to carry out the mapping.

11. The system as claimed in claim 10, wherein said merchants use devices to carry out the mapping, and said authentication consists of determining if said devices are associated with unique identifiers pre-registered at said server.

12. The system as claimed in claim 11, wherein the unique identifiers comprise mobile phone numbers, landline phone numbers, IP addresses or MAC addresses.

13. The system as claimed in claim 8, wherein said mapping is conducted by the users at the time of conducting the financial transactions, the financial values associated with the value-related phone numbers being reset after the completion of the financial transactions.
